(19) United States
(12) Patent Application Publication
(10) Pub. No.: US 2003/0163757 A1
(43) Pub. Date: Aug. 28, 2003

(54) RAID subsystem and data input/output and recovery method in disk error mode

(76) Inventors: Dong Jae Kang, Daejeon (KR); Bum Joo Shin, Daejeon (KR); Chang-Soo Kim, Daejeon (KR); Young Ho Kim, Daejeon (KR); Yuhyeon Bak, Daejeon (KR)

Correspondence Address: JACOBSON HOLMAN PLLC, 400 SEVENTH STREET N.W., SUITE 600, WASHINGTON, DC, 20004, US

(21) Appl. No.: 10/173,658

(22) Filed: Jun. 19, 2002

(30) Foreign Application Priority Data
Feb. 25, 2002 (KR) 2002-09859

(51) Int. Cl. H02H 3/05

(52) U.S. Cl. 714/6

(57) ABSTRACT

A RAID subsystem to distributively store data in a disk array having a plurality of disk drives and performing an I/O of the data in parallel is provided. A sparing disk drive stores a recovery image in which recovery information on a block of an error disk drive is recorded. A disk array controller retrieves the recovery information recorded in the recovery image according to a data input/output request of a host computer to check whether the block of the error disk drive is recovered or not. The regenerated block in the block of the sparing disk drive is recorded according to the check result on the block. The recovery information on the regenerated block is recorded in the recovery image.

### FIELD OF THE INVENTION

The present invention relates to a redundant arrays of independent disks (RAID) subsystem; and, more particularly, to a RAID subsystem to improve input/output performance and availability of data and a data input/output and recovery method in a disk error mode by using the RAID subsystem.

### BACKGROUND OF THE INVENTION

An explosive data increase, which is caused by a rapid development of Internet, has brought a lot of changes to a prior art on storage devices. The prior art on storage devices is deeply concerned to engraft the existing RAID into a storage area network (SAN) environment for the sake of input/output (I/O) performance, reliability, availability and storage management on large data.

The RAID stores data distributively in a disk array constituted with a plurality of disk drives so that it performs the data I/O in parallel with a quick process. Therefore, the RAID is a technique to guarantee a high I/O performance and to guarantee a reliability and a high availability to make a data recovery possible by using simple parity information when an error occurs.

The RAID is classified into six RAID levels (level 0-level 5) according to its characteristics. Each RAID level has advantages and disadvantages and, therefore, has been used in several application fields. Further, each RAID level provides reliability in a plurality of data storage devices.

Especially, a structure of a level 5 RAID subsystem among the six RAID level structures, which is applied to the present invention, will now be described with reference to FIG. 8.

FIG. 8 is a block diagram of a disk array structure, wherein an additional sparing disk to support an I/O and recovery method in accordance with the present invention is added to a conventional disk array structure of the level 5 RAID subsystem.

The disk array in the level 5 RAID subsystem includes five disk drives S1-S5 and one sparing disk drive SP. Each of the disk drives S1-S5 has a storage space constituted with n blocks BLK0-BLKn-1 and a unit block size is called as a striping size. Data are sequentially stored in the first blocks BLK0 of the disk drives S1-S5. After the first blocks BLK0 are filled, data are stored in the second blocks BLK1 in order. That is, a sequence for storing data in the disk array is as follows: the first block BLK0 of the disk drive S1→the first block BLK0 of the disk drive S2→ . . . →the first block BLK0 of the disk drive S5→the second block BLK1 of the disk drive S1→the second block BLK1 of the disk drive S2→ . . . →the n-^{th} block BLKn-1 of the disk drive S5.

By using the arrangement technique described above parity data are stored distributively in the disk drives S1-S5.

The sparing disk drive SP is not used when the disk array is normally operated. If a certain disk drive of any disk array is out of order, the out-of-order disk drive is replaced with the sparing disk drive SP. If S1 among the disk drives is out of order, a disk array controller recovers data in the disk drive S1 by performing an exclusive OR (XOR) operation on data in the remaining disk drives S2-S5 and records the recovered data in the sparing disk drive SP.

When an error is detected in one of the disk drives S1-S5, the conventional sparing disk drive SP installed in the disk array of a prior art is simply used to recover the disk drive.

To recover a disk drive with an error in the RAID subsystem, a sparing disk drive SP may be used. The sparing disk drive is classified into a dedicated sparing scheme, a distributed sparing scheme, a parity sparing scheme and so on.

The dedicated sparing scheme, which is called an online sparing disk type, immediately recovers a disk by using a sparing disk when an error is detected in the disk. Here, the sparing disk is used only when the disk error occurs. The distributed sparing scheme and the parity sparing scheme do not have an extra sparing disk. In those schemes, recovery blocks are distributed in a plurality of disks of the RAID subsystem so that a bottleneck in a certain disk may be prevented when an error occurs and the disk with the error may be quickly recovered.

Since, however, the method above is used to recover data when an error is detected in a disk, an operation process required to recover a block of the error disk drive in a data input/output process of a disk error mode may not guarantee a disk performance in a data I/O. Further, I/O response time may be deteriorated because data must be inputted/outputted through the operation process.

Further, since data recorded in the error block of the error disk drive of the disk array is recovered by performing a parity operation for all the blocks of the error disk drive, a system load may be increased so that a system performance may be deteriorated.

To solve these problems, there is a method for changing a parity block into a general data block to improve the I/O performance and availability in the disk error mode when a disk error occurs.

However, all the data of the disk must be recovered and data stored in the existing parity block must be moved into an appropriate position in order to recover the disk with the error.

### SUMMARY OF THE INVENTION

It is, therefore, a primary object of the present invention to provide a RAID subsystem for inputting/outputting and recovering data in a disk error mode by using a sparing disk with a recovery image in which recovery information on a block of an error disk drive in a disk array is recorded.

Another object of the present invention is to provide a data output method of the RAID subsystem for regenerating a block of the error disk drive having data to be outputted by a host computer, recording the data in a block of a sparing disk drive, recording recovery information in a recovery image of the sparing disk drive and using the block of the sparing disk drive to output the data.

Still another object of the present invention is to provide a data input method of the RAID subsystem for producing a parity value by an operation between data to be recorded in the block of the error disk drive and data recorded in a block of a normal disk drive, recording the parity value in a block of a predetermined disk drive, recording the data to be recorded in the block of the error disk drive in a block of a sparing disk drive and recording recovery information on the error disk drive in a recovery image.

Still another object of the present invention is to provide a data recovery method of the RAID subsystem for selectively recovering data stored in the block of the error disk drive in an unrecovered block by using the recovery information stored in the recovery image of the sparing disk drive.

In accordance with one aspect of the invention, there is provided a RAID subsystem for distributively storing data in a disk array having a plurality of disk drives and performing an I/O of the data in parallel, including:

a sparing disk drive for storing a recovery image in which recovery information on a block of an error disk drive is recorded, wherein the error disk drive is a disk drive with an error; and

a disk array controller for retrieving the recovery information recorded in the recovery image according to a data input/output request of a host computer to check whether the block of the error disk drive is recovered or not, regenerating the block according to the check result on the block to record the regenerated block in the block of the sparing disk drive and recording recovery information on the regenerated block in the recovery image.

In accordance with another aspect of the invention, there is provided a data output method of a RAID subsystem for outputting data in a disk array when an error occurs in the disk drive having a plurality of disk drives and a sparing disk drive storing a recovery image in which recovery information on a block of an error disk drive is recorded, wherein the error disk drive is a disk drive with an error, the method including the steps of:

(a) checking whether there is the recovery information on the block of the error disk drive in which the data has been recorded by inspecting the recovery image according to a data output request for the disk array of a host computer;

(b) regenerating the block of the error disk drive when there is no recovery information in step (a);

(c) recording data of the regenerated block in a block of the sparing disk drive;

(d) recording the recovery information on the block of the error disk drive in the recovery image after step (c); and

(e) outputting the data requested by the host computer into the host computer by using the recovery image.

In accordance with still another aspect of the invention, there is provided a data input method of a RAID subsystem for inputting data in a disk array when an error occurs in the disk drive having a plurality of disk drives and a sparing disk drive storing a recovery image in which recovery information on a block of an error disk drive is recorded, wherein the error disk drive is a disk drive with an error, including the steps of:

(a) checking whether there is the recovery information on the block of the error disk drive in which the data has been recorded by inspecting the recovery image according to a data input request for the disk array of a host computer;

(b) if there is no recovery information in step (a), recording a parity value generated by a parity operation on data to be recorded in the block of the error disk drive and data stored in one or more normal disk drives in a parity block of one of the disk drives;

(c) recording the data to be recorded in the block of the error disk drive in the block of the sparing disk drive; and

(d) recording the recovery information on the block of the error disk drive in the recovery image after step (c).

In accordance with still another aspect of the invention, there is provided a data recovery method of a RAID subsystem for recovering data in a disk array when an error occurs in the disk drive having a plurality of disk drives and a sparing disk drive storing a recovery image in which recovery information on a block of an error disk drive is recorded, wherein the error disk drive is a disk drive with an error, including the steps of:

(a) checking whether there is one or more unrecovered blocks by inspecting the recovery information recorded in the recovery image according to a data recovery request for the error disk drive of a host computer;

(b) if there is the unrecovered block in step (a), performing a parity operation on data recorded in a block of one or more normal disk drives to recover the block of the error disk drive; and

(c) storing data of the recovered block of the error disk drive in the block of the sparing disk drive.

### BRIEF DESCRIPTION OF THE DRAWINGS

The above and other object and features of the present invention will become apparent from the following description of preferred embodiments, given in conjunction with the accompanying drawings, in which:

FIG. 1 is a block diagram of a level 5 RAID subsystem in accordance with the present invention;

FIG. 2 is an exemplary diagram of a data output process using the RAID subsystem in accordance with the present invention;

FIG. 3 is a flowchart of the data output process using the RAID subsystem in accordance with the present invention;

FIG. 4 is an exemplary diagram of a data input process using the RAID subsystem in accordance with the present invention;

FIG. 5 is a flowchart of the data input process using the RAID subsystem in accordance with the present invention;

FIG. 6 is an exemplary diagram of a data recovery process using the RAID subsystem in accordance with the present invention;

FIG. 7 is a flowchart of the data recovery process using the RAID subsystem in accordance with the present invention; and

FIG. 8 is a block diagram schematically describing a level 5 RAID subsystem in accordance with a prior art.

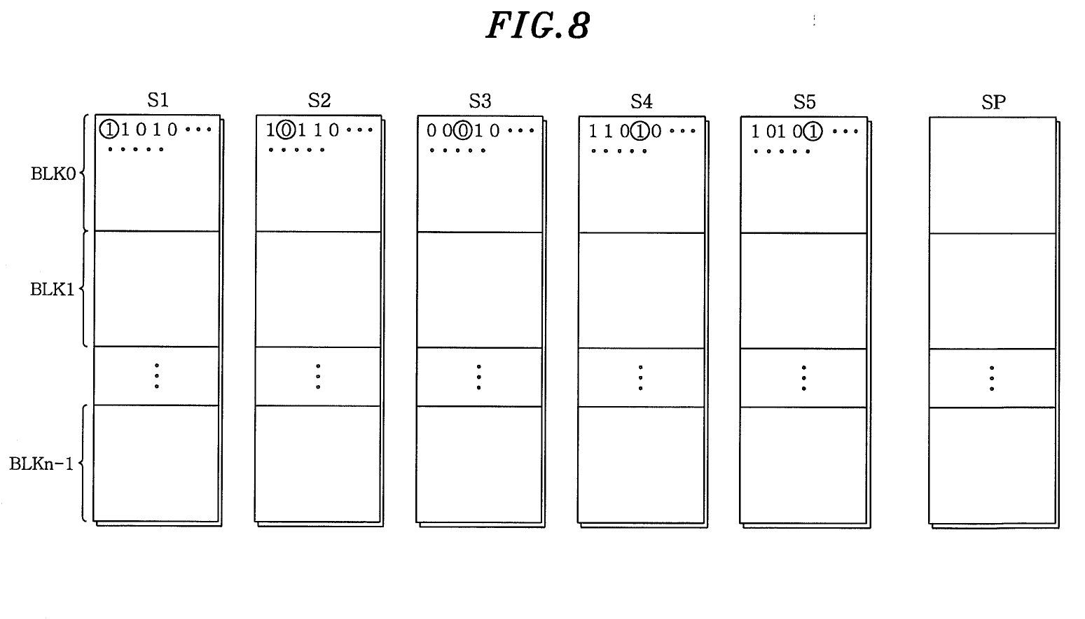

### DETAILED DESCRIPTION OF THE PREFERRED EMBODIMENTS

There may exists a plurality of preferred embodiments of the present invention, and preferred embodiments will be described in detail with reference to the accompanying drawings.

Further, there are provided a lot of details such as the number of disk drives within a disk array in order to help a better understanding of the present invention. However, it will be apparent to those skilled in the art that the present invention can be realized without those details.

A disk array constituted with a plurality of disks in a preferred embodiment of the present invention has a structure of a level 5 RAID subsystem.

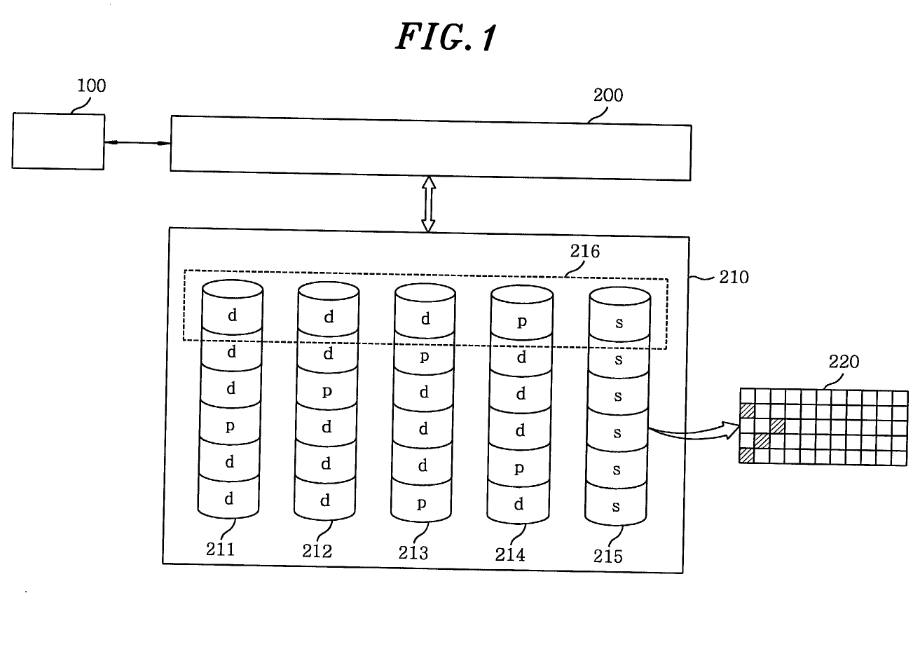

FIG. 1 is a block diagram of a level 5 RAID subsystem in accordance with the present invention. The RAID subsystem includes a disk array controller 200 connected to a host mobile 100 through a bus and a disk array 210 including a plurality of disk drives 211-214 and a sparing disk drive 215 and connected to the disk array controller 200 through a bus. The disk array controller 200 dispersedly stores data in the disk drives 211-214 and performs an I/O process in parallel. Also, the disk array controller 200 performs an I/O process for data to be inputted/outputted in an error detected disk drive by using the sparing disk drive 215.

Each of the disk drives 211-214 includes a plurality of data units (d) and a plurality of parity units (p), wherein each data unit (d) is a unit block for storing data and each parity unit (p) is a unit block for storing parity. The size of each data unit (d) is equal to that of each parity unit (p). A set of a plurality of data units (d) and a parity unit (p), which are positioned on the same blocks in the disk drives 211-214 respectively, is called as a stripe unit 216.

The sparing disk drive 215 includes a sparing disk recovery bitmap 220 to check whether sparing disk blocks are recovered or not. The block of the error detected disk drive is recovered according to a data I/O request of the host computer 100, and data in the recovered block is stored in a block of the sparing disk drive 215. Then, recovery information to inform that a corresponding block of the error detected disk drive is recovered is recorded in the recovery bitmap 220.

The disk array controller 200 retrieves the recovery information recorded in the recovery bitmap according to a data I/O request and a recovery request from the host computer 100 to check whether the block of the error detected disk drive is recovered or not. According to the check result, the block of the error detected disk drive is regenerated. Data in the regenerated block is recorded in the block of the sparing disk drive, and recovery information on the block of the error detected disk drive is recorded in the recovery bitmap.

Data stored in the sparing disk drive 215 is retrieved according to the I/O request of the host computer 100. Not only the retrieved data but also data retrieved from a disk drive having no error are transmitted to the host computer 100 by the disk array controller 200.

The control of the sparing disk drive 215 by the disk array controller 200 is divided into an initialization control mode, a normal control mode and a data recovery control mode for recovering data when a disk error occurs. Since the initialization control mode and the normal control mode in the present invention have the same operations as the conventional level 5 RAID subsystem has, in the present invention only the disk drive error mode of the level 5 RAID subsystem will be described.

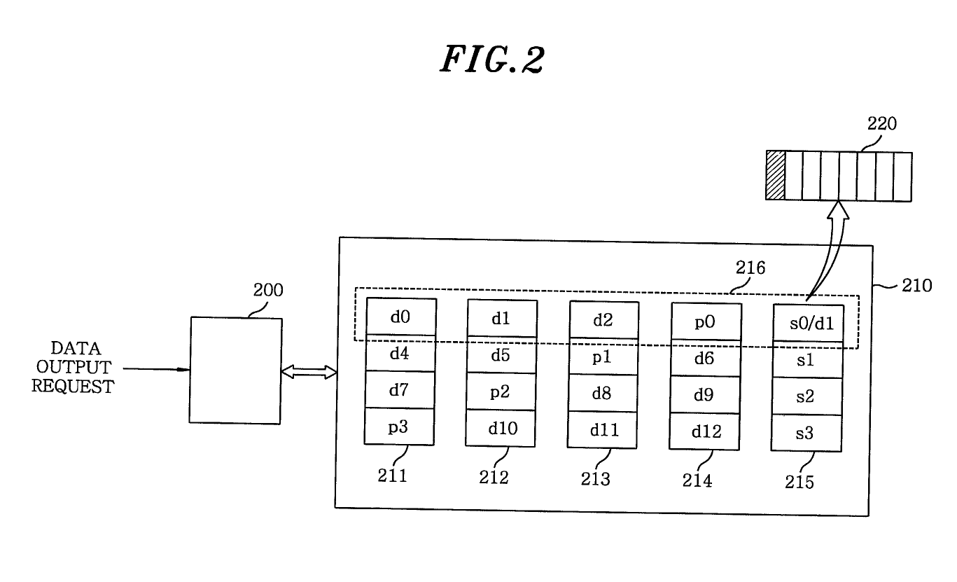

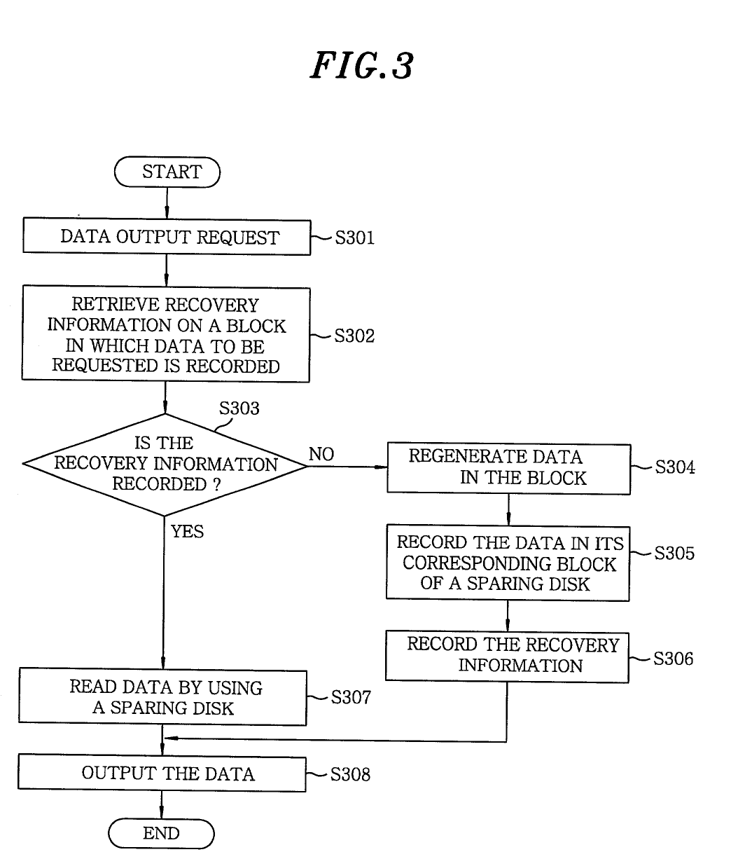

FIG. 2 is an exemplary diagram of a data output process in the disk drive error mode of the level 5 RAID subsystem in accordance with the present invention. FIG. 3 is a flowchart of the data output process of the RAID subsystem in accordance with the present invention.

First, it is assumed that the disk drive 212 is an error disk drive and the host computer 100 has requested an output on a data unit block d1 in a disk drive 212 of the disk array 210.

The disk array controller 200 checks whether recovery information on the corresponding block d1 is recorded or not in the recovery image 220 of the sparing disk drive 215 before an output operation is performed according to the data output request from the host computer 100 (steps S301 to S303).

If it is determined that recovery information on the data unit d1 is not recorded in the recovery image 220 in step S303, the disk array controller 200 reads out data and parity units d0, d2 and p0 in the disk drives 211, 213 and 214 in the stripe unit 216 of the data unit d1 in order to regenerate the data unit d1 that is a block of the error disk drive 212. After performing a parity operation by using the data and the parity units d0, d2 and p0, the disk array controller 200 regenerates the error data unit d1 (step S304).

After regenerating the error data unit d1, the disk array controller 200 records the regenerated data unit d1 in a block s0 of the sparing disk drive 215, wherein the block S0 is in the stripe unit of the error data unit d1 of the error disk drive 212. Then, the disk array controller 200 records recovery information in the recovery image 220 to inform that data stored in the block d1 of the error disk drive 212 is recovered in the sparing disk drive 215. Data is read out by using the sparing disk drive 215 and the disk drives 211, 213 and 214 having no error and transmitted to the host computer 100 (steps S305, S306 and S308).

If it is determined that recovery information on the data unit d1 of the error disk drive 212 is recorded in the recovery image 220 in step S303, the disk array controller 200 detects that the data unit d1 has been recovered in a block s0 of the sparing disk drive 215. Data requested by the host computer 100 is read out by using the data and the parity units d0, d2 and p0 of the disk drives 211, 213 and 214 that correspond to the unit 216 of the data unit d1 and the data unit d1 recovered in the block s0 of the sparing disk drive 215. The data read out is outputted into the host computer 100 (steps S307 and S308).

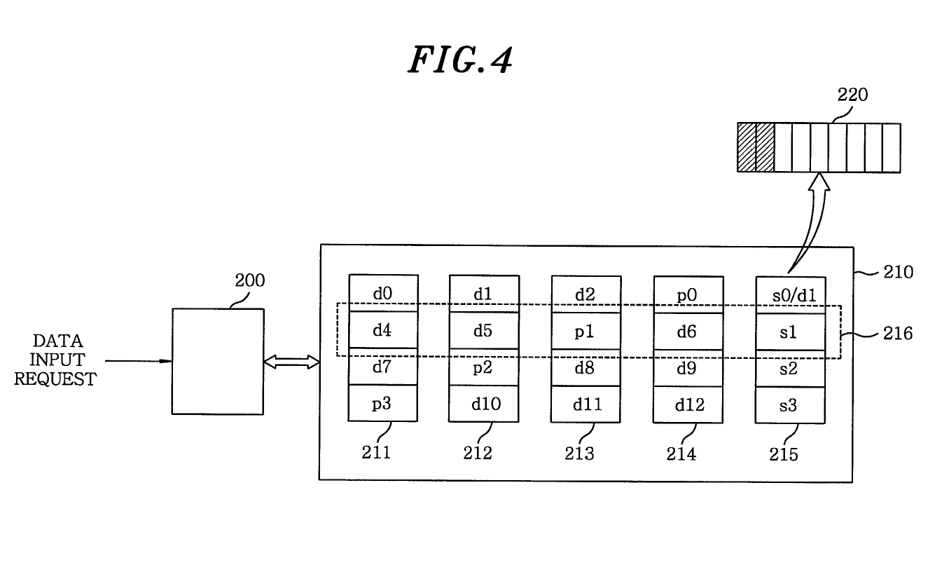

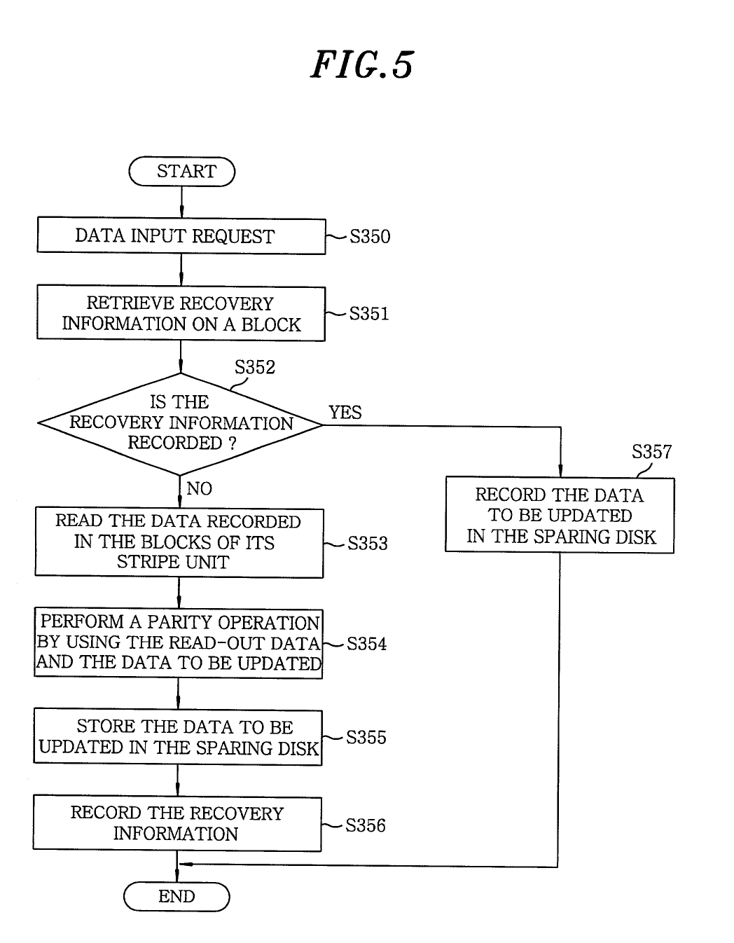

FIG. 4 is an exemplary diagram of a data input process of the RAID subsystem in accordance with the present invention. FIG. 5 is a flowchart of the data input (or storing) process of the RAID subsystem in accordance with the present invention.

It is assumed that the host computer 100 has requested the data input into a block d5 of the error disk drive 212.

Before performing an input operation according to the data input request of the host computer 100, the disk array controller 200 checks whether recovery information on the data unit d5 of the error disk drive 212 is recorded in the recovery image 220 or not (steps S350 to S352).

If it is determined that the recovery information on the data unit d5 is not recorded in the recovery image 220 in step S352, the disk array controller 200 performs a parity calculation by using data recorded in data units d4 and d6 included in the stripe unit 216 that corresponds to the block d5 and data to be inputted into the data unit d5 (step S353). And then, the calculated parity value is recorded in a parity block p1 (step S354).

After recording the parity value in the parity block p1, the disk array controller 200 stores data to be inputted into the data unit d5 of the error disk drive 212 in the sparing disk drive 215. Here, the block of the sparing disk drive 215, where data to be inputted into the data unit d5 of the error disk drive 212 is stored, is a block s1 in the stripe unit 216 corresponding to the block of the data unit d5 (step S355).

After recording data in the block s1 of the sparing disk drive 215, the disk array controller 200 records recovery information in the recovery image 220 to inform that data to be inputted into the data unit d5 of the error disk drive 212 has been recorded (step S356).

If it is determined that the recovery information on the data unit d5 has been recorded in the recovery image 220 in step S352, the disk array controller 200 performs a parity calculation by using data recorded in the data units d4 and d6 of the stripe unit 216 corresponding to the block d5 and data to be inputted in the block d5 in order to calculate the parity value to be recorded in the parity block p1. Then, the calculated parity value is recorded in the parity block p1. Thereafter, data to be recorded in the data unit d5 of the error disk drive 215 is recorded in a block of the sparing disk drive 215 corresponding to the data unit d5 (step S357).

By recording data not in an error disk drive but in the sparing disk drive 215 and reading out the recorded data as described above, the host computer 100 can input/output the data according to a second or a later input/output request on the error disk in an error mode in the same manner as in a normal mode based on the recovery information on the recovery image 220 generated by an operation process on a certain new block.

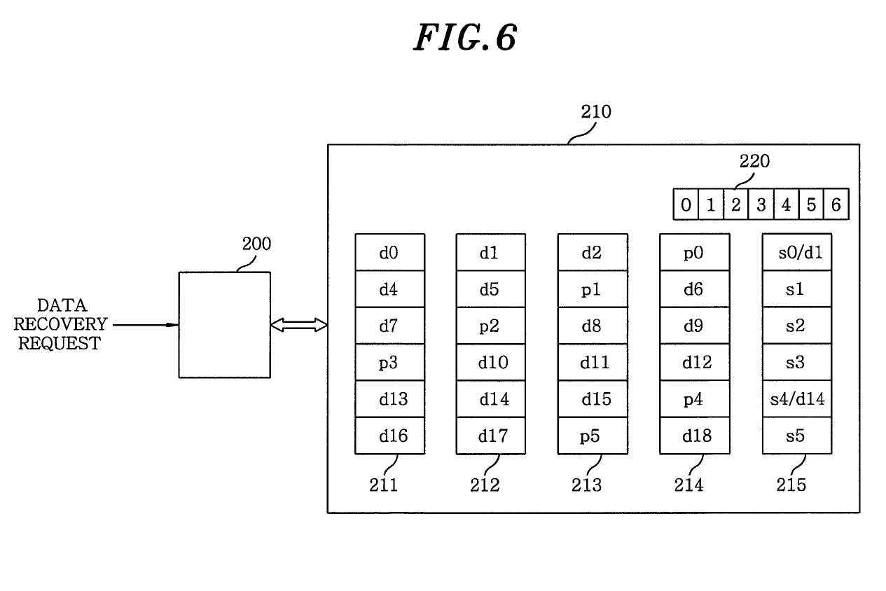

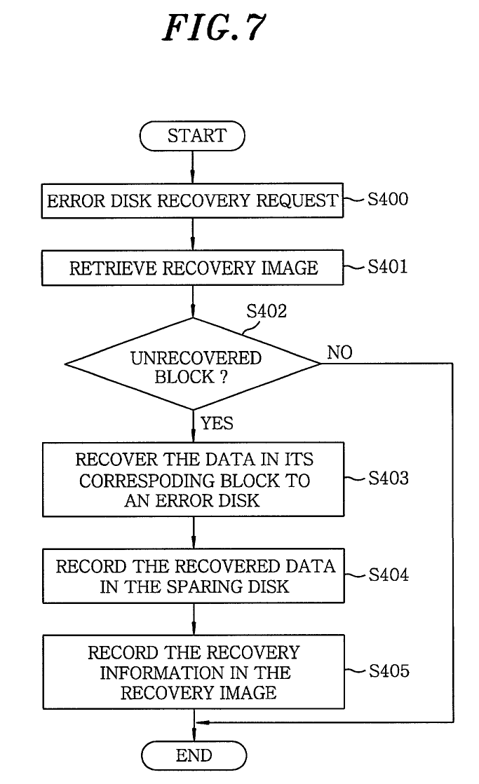

FIG. 6 is an exemplary diagram of a recovery process on data stored in an error disk drive of the RAID subsystem in accordance with the present invention. FIG. 7 is a flowchart of a recovery process on data stored in the error disk drive of the RAID subsystem in accordance with the present invention.

As described in FIG. 6, it is assumed that blocks s0, s1 and s4 in the sparing disk drive 215 are blocks in which an input/output request on the error disk drive 212 has been generated. The regenerated normal data has been recovered in the blocks S0, S1 and S4. The recovery information is recorded in the recovery image 220 to inform that the data has been regenerated in a corresponding block of the error disk drive 212.

As described in FIG. 7, the disk array controller 200 checks whether there is an unrecovered block in the error disk drive 212 by retrieving the recovery information recorded in the recovery image 220 according to the disk recovery request from the host computer 100 (steps S400, S401 and S403).

If it is determined that the unrecovered block, e.g., S2, exists in step S403, the disk array controller 200 recovers data recorded in a block p2 of the error disk drive 212 by an operation on data d7, d8 and d9 in the stripe unit 216 having the unrecovered block s2. The recovered data is recorded in a block s2 of the sparing disk drive 215. That is, s2/p2 is recorded in the block s2 of the sparing disk drive 215.

Then, the recovery information on the block p2 is recorded in the recovery image 220 in order to indicate that the block p2 of the error disk drive 212 has been recovered (step S405).

The recovery process described above will be repeated until there is no unrecovered block in the error disk drive 212 and, therefore, all unrecovered blocks in the error disk drive 212 have been recovered.

As described above, the present invention regenerates a block for a first new block of an error disk drive in order to input/output data. After data of the regenerated block in a block of a sparing disk drive is recorded, the recovery information is recorded in a recovery image to inform that the block has been recovered. Therefore, when there is a data input/output request on the recovered block, the data requested by a host computer can be inputted/outputted by using the block of the sparing disk drive without performing an operation process for recovering the block of the error disk drive so that a response time of a system in the error mode can be improved and a system load caused by the operation can be reduced.

Besides, the data stored in the block of the error disk drive can be recovered in the data input/output process and only the unrecovered blocks can be selectively recovered based on the recovery information on the recovery image generated during the recovery process of the error disk drive, so that the recovery cost and time may be reduced.

While the invention has been shown and described with respect to the preferred embodiments, it will be understood by those skilled in the art that various changes and modifications may be made without departing from the spirit and scope of the invention as defined in the following claims.

What is claimed is:

1. A RAID subsystem for distributively storing data in a disk array having a plurality of disk drives and performing an I/O of the data in parallel, comprising:
a sparing disk drive for storing a recovery image in which recovery information on a block of an error disk drive is recorded, wherein the error disk drive is a disk drive with an error; and
a disk array controller for retrieving the recovery information recorded in the recovery image according to a data input/output request of a host computer to check whether the block of the error disk drive is recovered or not, regenerating the block according to the check result on the block to record the regenerated block in the block of the sparing disk drive and recording recovery information on the regenerated block in the recovery image.

2. The system of claim 1, wherein the disk array controller selectively recovers the data based on the recovery information on the block of the error disk drive recorded in the recovery image according to a data recovery request from the host computer.

3. A data output method of a RAID subsystem for outputting data in a disk array when an error occurs in the disk drive having a plurality of disk drives and a sparing disk drive storing a recovery image in which recovery information on a block of an error disk drive is recorded, wherein the error disk drive is a disk drive with an error, the method comprising the steps of:
(a) checking whether there is the recovery information on the block of the error disk drive in which the data has been recorded by inspecting the recovery image according to a data output request for the disk array of a host computer;
(b) regenerating the block of the error disk drive when there is no recovery information in step (a);
(c) recording data of the regenerated block in a block of the sparing disk drive;
(d) recording the recovery information on the block of the error disk drive in the recovery image after step (c); and
(e) outputting the data requested by the host computer into the host computer by using the recovery image.

4. The method of claim 3, wherein, if there is the recovery information on the block of the error disk drive in step (a), data retrieved from the block of the sparing disk drive and one or more blocks of one or more disk drives having no error are provided to the host computer.

5. A data input method of a RAID subsystem for inputting data in a disk array when an error occurs in the disk drive having a plurality of disk drives and a sparing disk drive storing a recovery image in which recovery information on a block of an error disk drive is recorded, wherein the error disk drive is a disk drive with an error, comprising the steps of:
(a) checking whether there is the recovery information on the block of the error disk drive in which the data has been recorded by inspecting the recovery image according to a data input request for the disk array of a host computer;
(b) if there is no recovery information in step (a), recording a parity value generated by a parity operation on data to be recorded in the block of the error disk drive and data stored in one or more normal disk drives in a parity block of one of the disk drives;
(c) recording the data to be recorded in the block of the error disk drive in the block of the sparing disk drive; and
(d) recording the recovery information on the block of the error disk drive in the recovery image after step (c).

6. The method of claim 5, if there is the recovery information on the block of the error disk drive in step (a), data requested to be inputted by the host computer are recorded in the block of the sparing disk drive.

7. A data recovery method of a RAID subsystem for recovering data in a disk array when an error occurs in the disk drive having a plurality of disk drives and a sparing disk drive storing a recovery image in which recovery information on a block of an error disk drive is recorded, wherein the error disk drive is a disk drive with an error, comprising the steps of:
(a) checking whether there are one or more unrecovered blocks by inspecting the recovery information recorded in the recovery image according to a data recovery request for the error disk drive of a host computer;
(b) if there is the unrecovered block in step (a), performing a parity operation on data recorded in a block of one or more normal disk drives to recover the block of the error disk drive; and
(c) storing data of the recovered block of the error disk drive in the block of the sparing disk drive.
